(19) United States
(12) Patent Application Publication
(10) Pub. No.: US 2013/0047424 A1
(43) Pub. Date: Feb. 28, 2013

(54) BRAKE CALIPER PISTON ADJUSTER

(71) Applicant: ALFRED C. CHAVEZ, San Antonio, TX (US)

(72) Inventor: ALFRED C. CHAVEZ, San Antonio, TX (US)

(21) Appl. No.: 13/221,611

(22) Filed: Aug. 30, 2011

(51) Int. Cl. B23P 19/00

(52) U.S. Cl. 29/700

(57) ABSTRACT

A brake caliper piston adjuster includes a plate for adapting the adjuster to a brake caliper bracket. A spring provides compressive resistance between the plate and a washer, which has a piston adapter on an opposite side. A driver extension, which may be disposed through the plate, the center of the spring, and the washer, engages the piston adapter and allows a user to twistingly engage the piston adapter with a wrench.

### BACKGROUND OF THE INVENTION

The present invention generally relates to apparatus and methods for maintaining braking systems, and, more particularly, to a rear brake caliper piston adjuster.

Some devices for maintaining braking systems do not provide a tool that fits into a rear brake caliper and seats flush against a piston with tension to prevent the tool from slipping out of a piston slot during use. Other devices for maintaining braking systems require a user to exert effort to keep the device in place against a brake piston, and when consistent force is not used or the device is not flush against the brake piston, the device may slip out of place and damage a face of the brake piston or injure a user.

As can be seen, there is a need for an improved apparatus that provides a constant tension of a piston adapter on the caliper piston and maintains the piston adapter flush with the caliper piston.

### SUMMARY OF THE INVENTION

In one aspect of the present invention, a brake caliper piston adjuster kit for servicing an extension of a brake caliper piston in a brake caliper comprises a plate for adapting to a brake caliper bracket; a piston adapter for engaging a brake caliper piston face; a washer; a compression spring for providing compressive resistance between the plate and the washer; and an extension hole disposed in the plate and configured to receive a driver extension therethrough.

In another aspect of the present invention, a brake caliper piston adjuster, comprises a plate for adapting the brake caliper piston adjuster to a brake caliper bracket, wherein the plate includes an extension hole; a driver extension, wherein the driver extension includes a male extension on a first end, a female receiver on a second end, and a shaft disposed therebetween, wherein the driver extension is disposed through the extension hole; a spring, wherein the spring has a first and a second end, wherein the spring is situated on a side of the plate on the first end, and wherein the spring has the driver extension disposed therein; a washer, wherein the washer is assembled to the second end of the spring, and wherein the driver extension is disposed through a center of the washer; a caliper adapter, wherein the caliper adapter is disposed on the male extension of the driver extension; and an extension hole formed in the plate and configured to receive the driver extension therethrough.

These and other features, aspects and advantages of the present invention will become better understood with reference to the following drawings, description and claims.

### BRIEF DESCRIPTION OF THE DRAWINGS

FIG. 1 is an oblique perspective view of a brake caliper piston adjuster according to an exemplary embodiment of the present invention;

FIG. 2 is an exploded perspective view of the brake caliper piston adjuster of FIG. 1; and

FIG. 3 is a side perspective view of the brake caliper piston adjuster of FIG. 1 shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a rear brake caliper piston adjuster that allows a user to service a piston that requires a twisting or screwing action to adjust an extension thereof.

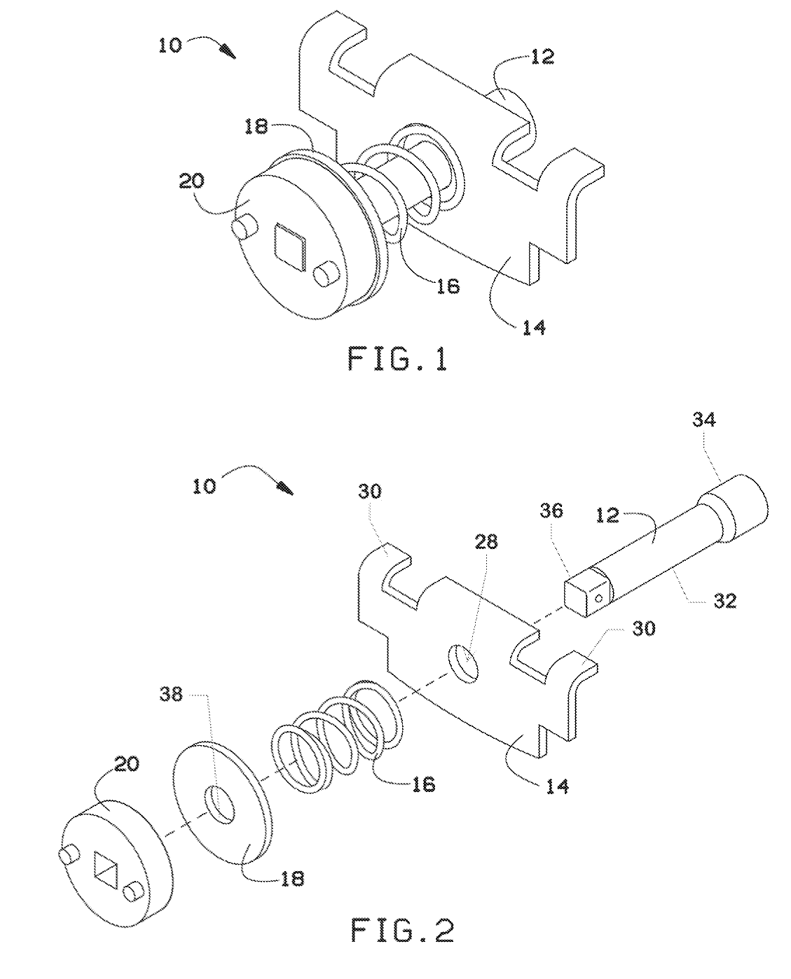

Referring to FIGS. 1 and 2, a brake caliper piston adjuster 10 includes a piston adapter 20 with a driver extension 12 assembled thereto. A washer 18 may be assembled to a side of piston adapter 20 and retain piston adapter 20 against a spring 16, which may have a plate 14 on an opposite side of spring 16. Plate 14, spring 16, and washer 18 may be configured to have driver extension 12 disposed through at least portions thereof such that driver extension 12 may engage piston adapter 20.

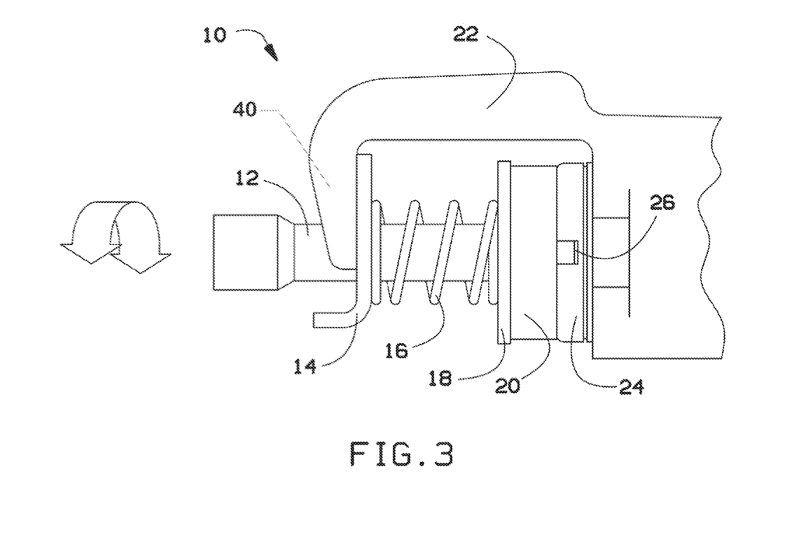

Referring to FIG. 3, brake caliper piston adjuster 10 is shown in use on a brake caliper 22, which may include a screw-in piston 24 having on or more screw-in piston slots 26 on a surface or face thereof. Piston adapter 20 may be configured to engage screw-in piston slots 26. Brake caliper 22 may include a caliper bracket 38, which may be opposite screw-in piston 24, and configured to receive plate 14.

Plate 14 may include an extension hole 28 formed, machined, or stamped therethrough. One or more tabs 30 may be disposed on a face or on an edge of plate 14, which may be stamped or pressed and configured to engage a surface of caliper bracket 38.

Driver extension 12 may include a female receiver 34 on a first end, a male extension 36 on a second end, and a shaft 32 disposed therebetween. Male extension 36 may include a square extension with a ball bearing retainer. Female receiver 34 may be configured to receive a square extension of a wrench (e.g., socket wrench), a second driver extension, or a pneumatic tool, for example. Spring 16 may be a compression spring that may be configured to have driver extension 12 pass through a center thereof. Spring 16 may be compressed on a first end by plate 14 and on a second end by washer 18, and therefore, may provide compressive resistance to plate 14 and washer 18.

According to some exemplary embodiment, shaft 32 may include a groove or channel (not pictured) formed or machined along a circumference thereof, which may be engaged by a snap clip, spring, circlip, or wrist pin retainer, for example.

According to other exemplary embodiments, driver extension 12 may include a grip (e.g., resin handle or knurled surface), a T-handle, or an L-handle (not pictured) on an end opposite male extension 36 to enable a tool-free operation of brake caliper piston adjuster 10.

According to one exemplary embodiment driver extension 12 may be about 2 inch in overall length. Female receiver 34 and male extension 36 may be configured for about a ⅜ inch square face driver. Plate 14 may be about ⅛ inch thick. Extension hole 28 may be about ½ inch in diameter. Spring 16 may be configured with a spring rate to exert about 15 pounds of force to piston 24 when brake caliper piston adjuster 10 is installed in brake caliper 22. Spring 16 may be about 1.5 inches in length (uncompressed) and about 1 inch in diameter. Washer 18 may have about a 1 inch outside diameter and about a 7/16 inch inside diameter.

It should be understood, of course, that the foregoing relates to exemplary embodiments of the invention and that modifications may be made without departing from the spirit and scope of the invention as set forth in the following claims.

What is claimed is:

1. A brake caliper piston adjuster kit for servicing an extension of a brake caliper piston in a brake caliper, the adjuster kit comprising:
a plate for adapting to a brake caliper bracket;
a piston adapter for engaging a brake caliper piston face;
a washer;
a compression spring for providing compressive resistance between the plate and the washer; and
an extension hole disposed in the plate and configured to receive a driver extension therethrough.

2. The brake caliper piston adjuster kit of claim 1, further comprising the driver extension, wherein the driver extension is capable of being disposed through the plate, the compression spring, and the washer, and wherein the driver extension is capable of engaging the piston adapter.

3. The brake caliper piston adjuster kit of claim 2, wherein the driver extension comprises:
a shaft; and
a female receiver, wherein the extension hole is configured to allow the shaft to pass therethrough, and the extension hole is configured to prevent the female receiver from passing therethrough.

4. The brake caliper piston adjuster kit of claim 1, further comprising a second piston adapter, wherein the second piston adapter is configured to engage a second brake caliper piston face.

5. The brake caliper piston adjuster kit of claim 1, further comprising a second plate, wherein the second plate is configured to adapt to a second brake caliper bracket.

6. The brake caliper piston adjuster kit of claim 1, further comprising:
a second driver extension; and
a second compression spring, wherein the second driver extension and the second compression spring are configured to adapt to a second brake caliper.

7. A brake caliper piston adjuster, comprising:
a plate for adapting the brake caliper piston adjuster to a brake caliper bracket, wherein the plate includes an extension hole;
a driver extension, wherein the driver extension includes a male extension on a first end, a female receiver on a second end, and a shaft disposed therebetween, wherein the driver extension is disposed through the extension hole;
a spring, wherein the spring has a first and a second end, wherein the spring is situated on a side of the plate on the first end, and wherein the spring has the driver extension disposed therein;
a washer, wherein the washer is assembled to the second end of the spring, and wherein the driver extension is disposed through a center of the washer;
a caliper adapter, wherein the caliper adapter is disposed on the male extension of the driver extension; and
an extension hole formed in the plate and configured to receive the driver extension therethrough.

8. The brake caliper piston adjuster of claim 7, wherein the washer includes an inside surface for engaging an outer surface of a shaft of the driver extension, wherein the inside surface engages the outer surface by an interference fit.

9. The brake caliper piston adjuster of claim 7, wherein the caliper adapter is configured to adapt to a piston of a rear brake caliper, wherein an outer surface of a shaft of the driver extension includes a groove on a -segment of a circumference of the shaft, the brake caliper piston adjuster further comprising a retaining clip, wherein the retaining clip is configured to engage the groove and wherein the retaining clip is configured to retain the washer in place against a force of the spring.

10. The brake caliper piston adjuster of claim 9, wherein:
the retaining clip is chosen from a group consisting of a snap ring, a cotter pin, and-a snap ring;
the snap ring is configured to engage the groove, and
the snap ring is configured to retain the washer in place against a spring force of the spring.
